(19) United States
(12) Patent Application Publication
(10) Pub. No.: US 2013/0222289 A1
(43) Pub. Date: Aug. 29, 2013

(54) FLEXIBLE TERMINAL AND CONTROL METHOD THEREOF

(71) Applicant: PANTECH CO., LTD., Seoul (KR)

(72) Inventor: Myoung Hoon KWAK, Seoul (KR)

(73) Assignee: PANTECH CO., LTD., SEOUL (KR)

(21) Appl. No.: 13/713,602

(22) Filed: Dec. 13, 2012

(30) Foreign Application Priority Data
Feb. 27, 2012 (KR) 10-2012-0019685

(51) Int. Cl. G06F 3/041

(52) U.S. Cl. CPC G06F 3/041
USPC 345/173

(57) ABSTRACT

Provided is a flexible terminal including a body, a flexible control display provided on one side of the body, and a control unit which processes a control signal inputted through the control display. The control display includes a piezoelectric member, which is divided into one or more cells, and one or more conductive members, which are formed of a conductive material. The control display may recognize a touch signal through a touch type method or a piezoelectric signal by a deformation of the piezoelectric member.

### CROSS-REFERENCE TO RELATED APPLICATION

This application claims priority from and the benefit of Korean Patent Application No. 10-2012-0019685, filed on Feb. 27, 2012, which is hereby incorporated by reference for all purposes as if fully set forth herein.

### BACKGROUND

1. Field

Exemplary embodiments of the present invention relate to a flexible terminal, and more particularly, to a flexible terminal capable of inputting a control signal according to flexing of a flexible control display.

2. Discussion of the Background

A terminal, which allows a user to exchange a signal with others, such as a cellular phone, a Personal Communication Service (PCS), a Personal Digital Assistant (PDA), a tablet computer, and the like, is provided in a variety of forms so that a user may communicate with others while in motion. That is, the terminal is provided in various forms, such as a form in which a flat panel display is provided, a form in which multiple stages are foldably provided and a display is selectively expandable, a form in which a plurality of bodies are configured to selectively open a display, and the like.

Recently, a variety of control methods for expanding the diversity of usability as well as for improving controllability are being suggested. In particular, as sizes of displays are enlarged, a method for inputting a control signal using the display, for example, a touch type method, is becoming more widespread. Thus, research is being continuously conducted with regard to inputting of control signals.

### SUMMARY

Exemplary embodiments of the present invention provide a flexible terminal and a method for controlling the same.

Additional features of the invention will be set forth in the description which follows, and in part will be apparent from the description, or may be learned by practice of the invention.

Exemplary embodiments of the present invention provide a flexible terminal including flexible control display to generate a piezoelectric signal in response to a deformation of the flexible control display: and a control unit configured to process a control signal in response to the piezoelectric signal received through the flexible control display.

Exemplary embodiments of the present invention provide a flexible terminal including a flexible control display to generate a touch signal in response to a touch and to generate a piezoelectric signal in response to a deformation of the flexible control display; a piezoelectric member divided into at least one cell within which a piezoelectric signal is generated; at least one conductive member connected to the at least one cell to receive the piezoelectric signal, and a control unit which processes a control signal corresponding to the touch signal and the piezoelectric signal.

Exemplary embodiments of the present invention provide a method for controlling a flexible terminal, the method including determining whether a piezoelectric signal exceeds a reference value; and processing a control signal corresponding to the piezoelectric signal if the piezoelectric signal exceeds the reference value.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view schematically illustrating a twisted state of a flexible terminal according to exemplary embodiments of the present invention.

FIG. 2 is a perspective view schematically illustrating the bent state of a flexible terminal according to exemplary embodiments of the present invention.

FIG. 3 is a cross-sectional view schematically illustrating a control display according to exemplary embodiments of the present invention.

FIG. 4 is an exploded perspective view schematically illustrating a part of a control display according to exemplary embodiments of the present invention.

FIGS. 5A, 5B, 5C, and 5D are diagrams schematically illustrating a piezoelectric state of first and second piezoelectric members according to exemplary embodiments of the present invention.

FIG. 6 is a cross-sectional view schematically illustrating a control display according to exemplary embodiments of the present invention.

FIG. 7 is a flowchart schematically illustrating a process for inputting a control signal of the flexible terminal according to exemplary embodiments of the present invention.

FIG. 8 is a cross-sectional view schematically illustrating a control display of a flexible terminal according to exemplary embodiments of the present invention.

FIG. 9 is a diagram schematically illustrating a piezoelectric member according to exemplary embodiments of the present invention.

FIG. 10 is a diagram schematically illustrating a piezoelectric member according to exemplary embodiments of the present invention.

FIG. 11 is a diagram schematically illustrating an input of a piezoelectric signal according to exemplary embodiments of the present invention.

FIG. 12 is a diagram schematically illustrating an input of a piezoelectric signal according to exemplary embodiments of the present invention

FIG. 13 is a diagram schematically illustrating an input of a piezoelectric signal according to exemplary embodiments of the present invention.

FIG. 14 is a diagram schematically illustrating an input of a piezoelectric signal according to exemplary embodiments of the present invention.

FIG. 15 is a diagram schematically illustrating an input of a piezoelectric signal according to exemplary embodiments of the present invention.

FIG. 16 is a diagram schematically illustrating an input of a piezoelectric signal according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like members.

It will be understood that when a member is referred to as being “connected to” another member, it may be directly connected to the other member, or intervening members may be present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

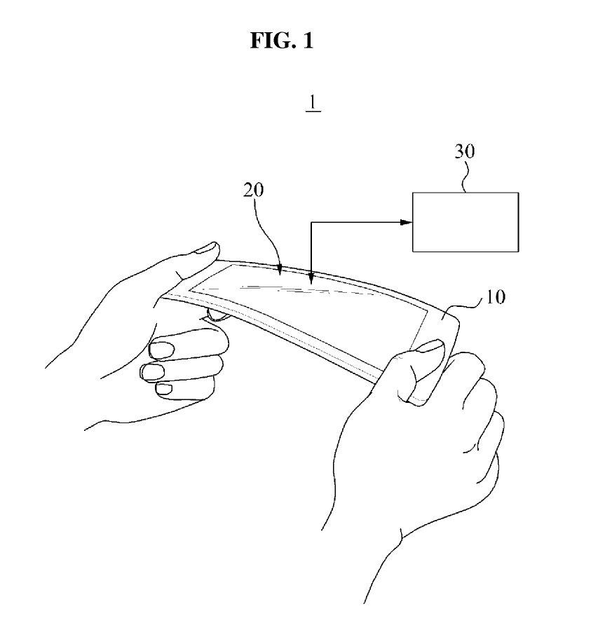

As shown in FIGS. 1 through 3, a flexible terminal 1 includes a body 10, a control display 20, and a control unit 30. Here, the flexible terminal 1 may include a variety of portable devices, such as a cellular phone, a smart phone, and a tablet personal computer (PC) as well as flexible devices which have flexibility so as to be transformable in shape.

The body 10 includes a body of the flexible terminal 1 that supports the control display 20 and the control unit 30. Although the body 10 as described herein has a relatively rectangular shape and the control display 20 is provided on the front side to be exposed, the shape of the body 10 and the exposed location of the control display 20 are not limited thereto such that the body 10 and the control display 20 may have other shapes, for example, a round, curved, elliptical, triangular, polygonal, or other shape, and the control display 20 may be exposed on a back side or on both sides of the body 10.

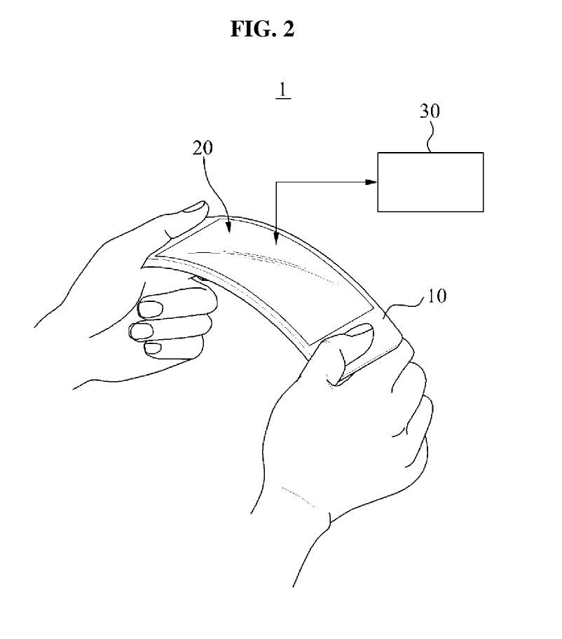

The control display 20, which is provided on the front side of the body 10, displays determined information or accepts inputs corresponding to a determined control signal. Here, the control display 20 is formed of a flexible material, so as to be twistable or bent in a state in which the control display 20 is mounted on the body 10, as shown in FIGS. 1 and 2. As described here, the control display 20 may be deformed, for example, twisted, bent, and the like. Twisting of the control display 20 may be deforming, rotating, or turning at least one end of the control display 20 about an axis of rotation, and bending of the control display 20 may be deforming at least one end of the control display 20 in a direction away from the control display 20 being generally planar so as to be curved or disposed at an angle.

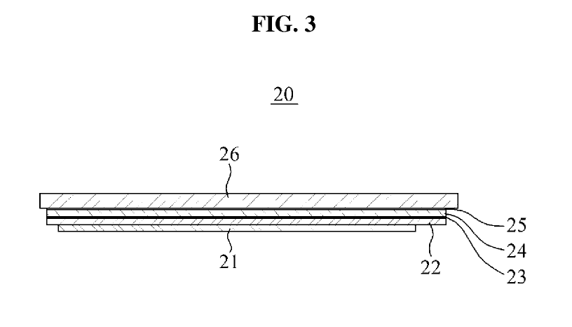

With reference to FIG. 3, the flexible control display 20 includes piezoelectric members 22 and 24 to recognize a touch signal through a touch type method in which a user touches the control display 20 as well as to recognize a piezoelectric signal in response to a deformation of the control display 20, for example, a twisting or a bending of the control display 20.

The control unit 30 processes a control signal recognized through the control display 20. That is, the control unit 30 processes a touch signal or a piezoelectric signal recognized through the control display 20. The control unit 30 may control a control signal as well as information to be displayed through the control display 20.

Referring to FIG. 3, the control display 20 is formed of a flexible material and includes a display member 21, one or more conductive members 23 and 25, one or more pairs of piezoelectric members 22 and 24, and a cover member 26 to provide a piezoelectric resource. As shown in FIG. 3, the display member 21, the first piezoelectric member 22, the first conductive member 23, the second piezoelectric member 24, the second conductive member 25, and the cover member 26 may be stacked in sequence starting from a bottom of the device.

The display member 21 includes any of various display panels formed of a flexible material, and displays information. The first piezoelectric member 22 is disposed on the display member 21 and is formed of a transparent piezoelectric film. The first conductive member 23 is disposed on the first piezoelectric member 22 and is formed of a transparent electrode material. The second piezoelectric member 24 is formed of a transparent piezoelectric film member and is disposed on the first conductive member 23. The second conductive member 25 is formed of a transparent electrode material and is disposed on the second piezoelectric member 24. The cover member 26, which is formed of a flexible material, is disposed on the second conductive member 25, and protects the first and second piezoelectric members 22 and 24 as well as the first and second conductive members 23 and 25, which are disposed between the cover member 26 and the display member 21. The first piezoelectric member 22 and the second piezoelectric member 24 may be formed of a same transparent piezoelectric film material. The first conductive member 23 and the second conductive member 25 may be formed of a same transparent electrode material. The first and second piezoelectric members 22 and 24 allow for a piezoelectric input to be received, and are also used as base substrates on which the first and second conductive members 23 and 25 may be disposed, such as a type of film.

The first and second conductive members 23 and 25 may be formed of a transparent electrode material, e.g., Indium Tin Oxide (ITO). In addition, a touch signal may be inputted by a touch type method through the first and second conductive members 23 and 25.

The first and second piezoelectric members 22 and 24 generate an electric signal, i.e., a piezoelectric signal, based on the twisting motion or the bending motion of the control display 20, and then provide the generated signal to a control unit 30. Here, the first and second piezoelectric members 22 and 24 include transparent polymer resin films, that is, a piezoelectric film, for example, polyvinylidene fluoride (PVDF), having a thickness of about 0.2 millimeters (mm). In this instance, metallically vapor deposited electrodes may be provided on both sides of at least one of the first and second piezoelectric members 22 and 24. The first and second piezoelectric members 22 and 24 are compressed or extended in response to a physical deformation, such as the bending motion or the twisting motion of the control display 20 in a specific direction, so as to generate an electric signal. That is, when a tensile stress or a compressive stress is applied to the first and second piezoelectric members 22 and 24 for example, an electric dipole moment from the outside, a change of state between molecules or ions configuring a crystal occurs. Accordingly, as the electric dipole moment is changed, a crystal structure is changed so that a peripheral magnetic field is modified. The modified magnetic field of the first and second piezoelectric members 22 and 24 generate a positive or a negative electric signal, so as to generate a piezoelectric signal, which is provided to the control unit 30.

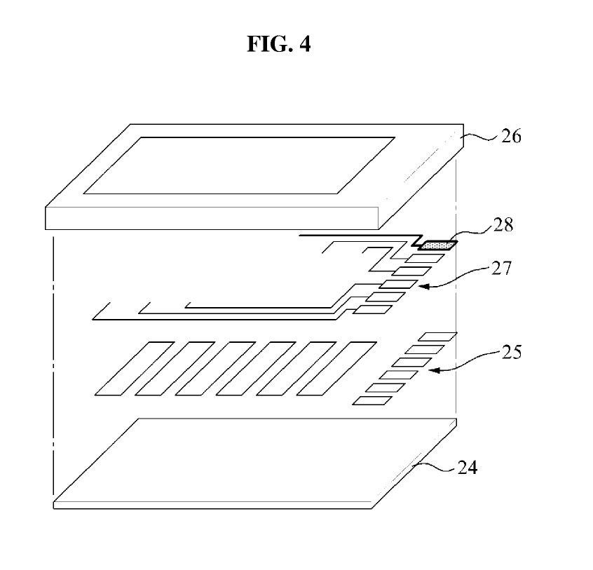

FIG. 4 is an exploded perspective view schematically illustrating a part of a control display according to exemplary embodiments of the present invention. Referring to FIG. 4, a state in which a conductive electrode 27 and a piezoelectric electrode 28 are disposed between the second conductive member 25 and the cover member 26 is illustrated in an exploded view. Here, the conductive electrode 27 is an electrode of the second conductive member 25, while the piezoelectric electrode 28 is an electrode of the second piezoelectric member 24. The conductive electrode 27 may extend from a side of the control display to a determined location of within the control display. The conductive electrode 27 may extend along a side of the control display. Further, the conductive electrode 27 may include a plurality of control electrodes 27 that extend in parallel from a side of the control display along a side or sides of the control display to respective determined locations of the control display. Similarly, the piezoelectric electrode 28 may include a plurality of piezoelectric electrodes 28 that extend in parallel from a side of the control display along a side or sides of the control display to respective determined locations of the control display. Although FIG. 4 merely illustrates the conductive electrode 27 and the piezoelectric electrode 28 corresponding to electrodes of the second conductive member 25 and the second piezoelectric member 24, respectively, the first conductive member 23 and the first piezoelectric member 22 may each have similar corresponding electrodes.

Table 1 shows an example of the extended or compressed state applied to the first and second piezoelectric members 22 and 24, the state of an electric signal, and the motion of the flexible terminal 1 according to each state, when the flexible terminal 1 is bent or twisted.

TABLE 1

| | | | | | | Electric signal | | | | |
|---|---|---|---|---|---|---|---|---|---|---|
| | | First | | Second | | First | | Second | | |
| | | piezoelectric | | piezoelectric | | conductive | | conductive | | |
| | | member | | member | | member | | member | | UI (User |
| Motion | | Top | Bottom | Top | Bottom | Top | Bottom | Top | Bottom | Interface) |
| mode | | side | side | side | side | side | side | side | side | (example) |
| Bent | Front | Extended | Compressed | Extended | Compressed | + | − | + | − | Backward |
| | Back | Compressed | Extended | Compressed | Extended | − | + | − | + | Forward |

| | | | | | | | | | |
|---|---|---|---|---|---|---|---|---|---|
| Twisted | Extended | Extended | Extended | Extended | + | + | + | + | Cancel |

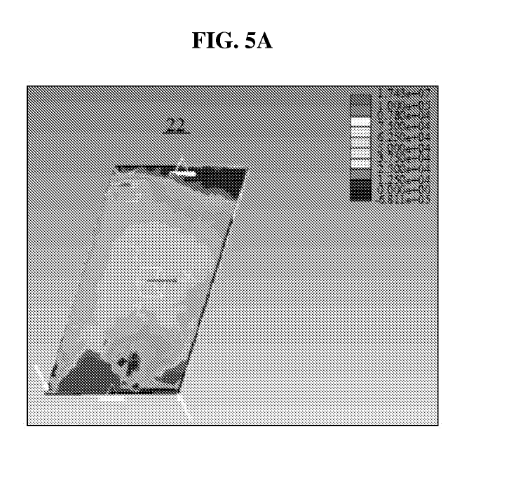

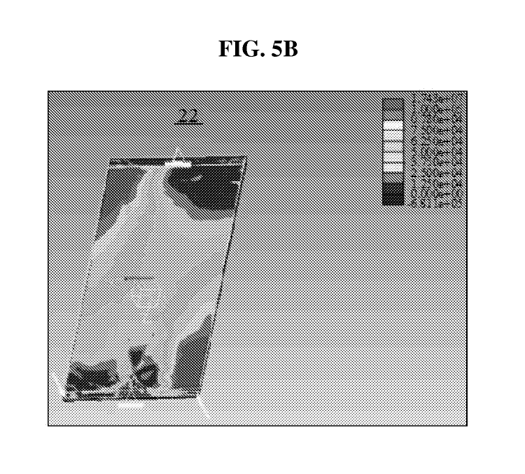

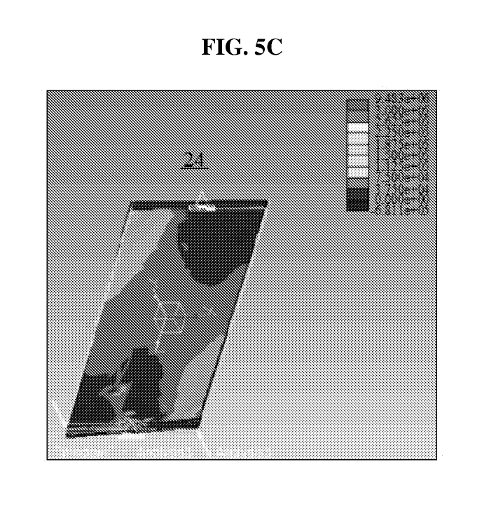

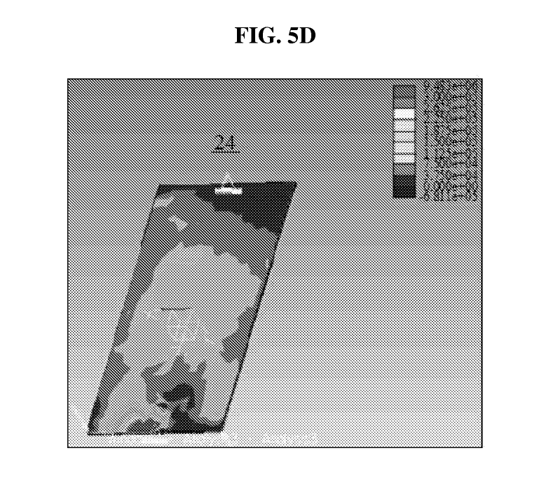

FIGS. 5A, 5B, 5C, and 5D are diagrams schematically illustrating a piezoelectric state of first and second piezoelectric members according to exemplary embodiments of the present invention. Referring to FIGS. 5A through 5D, the piezoelectric state in which the first and second piezoelectric members 22 and 24 are twisted is illustrated. FIGS. 5A and 5B show extended and compressed states of top and bottom sides of a first piezoelectric member 22, based on FIG. 3. Further, FIGS. 5C and 5D show extended and compressed states of top and bottom sides of a second piezoelectric member 24, based on FIG. 3. The darker sections, e.g., section 510, indicate a compressive stress is applied to the first and second piezoelectric members 22 and 24, while the lighter sections, e.g., section 520, indicate that a tensile stress is applied. That is, in FIGS. 5A, 5B, 5C, and 5D, the first and second piezoelectric members 22 and 24 are twisted, because a tensile stress is being applied to the first and second piezoelectric members 22 and 24. In this instance, a control signal “cancel” may be inputted through a control display 20 displayed on the flexible terminal 1, as shown in Table 1.

The display member 21 and the cover member 26 may be formed of flexible materials, and the first and second piezoelectric members 22 and 24, as well as the first and second conductive members 23 and 25 may be formed of transparent thin films so that the control display 20 is flexibly transformable.

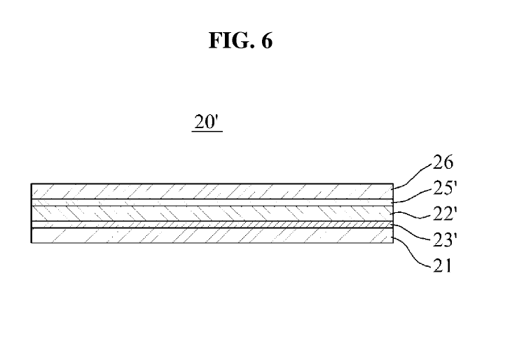

FIG. 6 is a cross-sectional view schematically illustrating a control display according to exemplary embodiments of the present invention. Referring to FIG. 6, control display 20′ of the flexible terminal 1 may include a display member 21, a first conductive member 23′, a piezoelectric member 22′, a second conductive member 25′, and a cover member 26 disposed sequentially. Here, only the single piezoelectric member 22′ is included. Accordingly, a number of piezoelectric members 22′ is not fixed and can be varied based on the number of piezoelectric signals to be used.

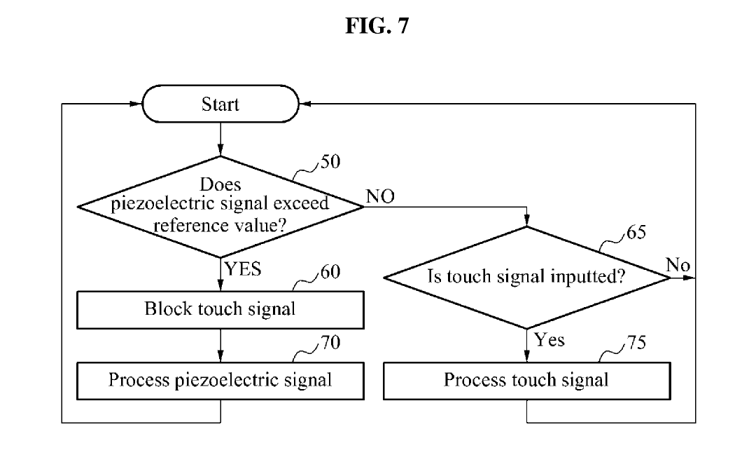

A method for recognizing a control signal through a control display 20 of the flexible terminal 1 having such a configuration according to exemplary embodiments of the present invention is described with reference to FIGS. 1 through 3 and FIG. 7. FIG. 7 is a flowchart schematically illustrating a process for inputting a control signal of the flexible terminal according to exemplary embodiments of the present invention. Although operations are described with respect to the flexible terminal 1, aspects need not be limited thereto such that the operations may be applied to other terminals.

As illustrated in FIGS. 1 and 2, a control display 20 provided in a body 10 is bendable or twistable by a user, i.e., the terminal 1 may be deformed. The first and second piezoelectric members 22 and 24 illustrated in FIG. 3 generate a piezoelectric signal, and then the generated piezoelectric signal is provided to a control unit 30, as illustrated in FIGS. 1 and 2. As illustrated in FIG. 7, the control unit 30 determines whether the inputted piezoelectric signal exceeds a determined reference value in operation 50. If the inputted piezoelectric signal exceeds the determined reference value in operation 50, the control unit 30 blocks a touch signal input through the control display 20 in operation 60. That is, when the flexible terminal 1 is twisted or bent, i.e., deformed, to such an extent that the inputted piezoelectric signal exceeds the reference value, the touch signal inputted by first and second conductive members 23 and 25 is blocked by the control unit 30, in operation 60. The control unit 30 also processes the recognized piezoelectric signal in operation 70.

If any deformation, such as a bending motion or a twisting motion, is not applied to the control display 20 included in the body 10, i.e., the flexible terminal 1 is deformed such that the piezoelectric signal does not exceed the reference value, the control unit 30 determines that the piezoelectric signal fails to exceed the reference value in operation 50. If the piezoelectric signal is determined to not exceed the reference value in operation 50, the control unit 30 determines whether a touch signal is inputted in operation 65. If a touch signal is recognized through the first and second conductive members 23 and 25, the control unit 30 processes the touch signal in operation 75.

Here, as shown in FIG. 7, although a piezoelectric signal may be recognized through the control display 20, the input of the touch signal being blocked is merely an example and is not limited thereto such that the piezoelectric signal and the touch signal may be inputted simultaneously to control the flexible terminal 1.

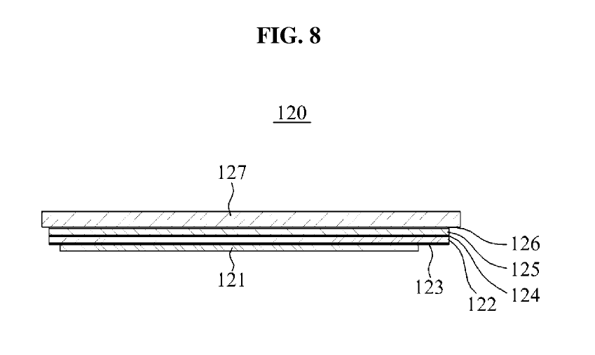

FIG. 8 is a cross-sectional view schematically illustrating a control display of a flexible terminal according to exemplary embodiments of the present invention. Referring to FIG. 8, a control display 120 is a schematically illustrated according to exemplary embodiments of the present invention in a cross-sectional view.

The control display 120 includes a display member 121, a first film member 122, a piezoelectric member 123, a first conductive member 124, a second film member 125, a second conductive member 126, and a cover member 127.

The display member 121 includes a flexible display, and displays information. The first film member 122 is disposed on the display member 121 and may be formed of a transparent material. The piezoelectric member 123 may be vapor deposited above or below the first film member 122. The first conductive member 124 may be transparent and disposed on the film member 122 where the piezoelectric member 123 is vapor deposited. The second film member 125 may be disposed on the first conductive member 124 and may be transparent. Here, the first film member 122 may also be transparent. The second conductive member 126 may be formed of a transparent material and may be disposed on the second film member 125, and the cover member 127 may be formed of a flexible and transparent material and may be disposed on the second conductive member 126, so that the control display 120 is finally provided.

As described in the foregoing, the information displayed through the display member 121 is not interfered with because the first film member 122, the piezoelectric member 123, the first and second conductive member 124 and 126, and the first and second film members 122 and 125, excluding the display member 121, may be transparent. In addition, the piezoelectric member 123 may be vapor deposited on a film material, such as the first film member 122, as well as a circuit board on which the piezoelectric member 123 may be vapor deposited, for example, one which is formed of a flexible material.

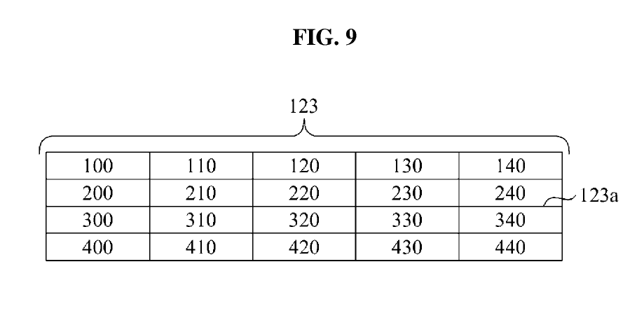

FIG. 9 is a diagram schematically illustrating a piezoelectric member according to exemplary embodiments of the present invention. As shown in FIG. 9, the piezoelectric member 123 may be divided into a plurality of cells 100, 110, 120, 130, and 140; 200, 210, 220, 230, and 240; 300, 310, 320, 330, and 340; and 400, 410, 420, 430, and 440, and each cell generates a piezoelectric signal independently. Here, the piezoelectric member 123 may be divided into a plurality of cells 100 to 140, 200 to 240, 300 to 340, and 400 to 440 by an etching line or a laser cutting line 123a. Although illustrated as a 4 by 5 matrix of cells, aspects need not be limited thereto such that the granularity of the piezoelectric member 123 and the piezoelectric member 123 may be divided into more or fewer cells.

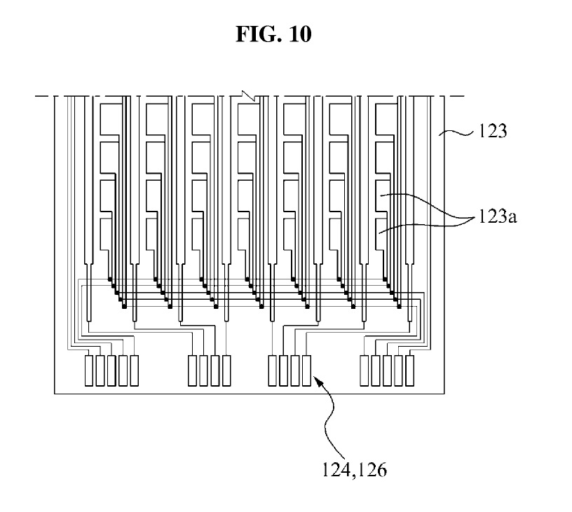

FIG. 10 is a diagram schematically illustrating a piezoelectric member according to exemplary embodiments of the present invention. FIG. 10 is a diagram schematically illustrating a state of the piezoelectric member 123. In this instance, referring to FIG. 10, first conductive members 124 and second conductive members 126 are provided on the piezoelectric member 123. In this instance, the first and second conductive members 124 and 126 are connected to a plurality of respective cells 100 to 140, 200 to 240, 300 to 340, and 400 to 440 and thus, the conductive state of the piezoelectric member 123 may be recognized.

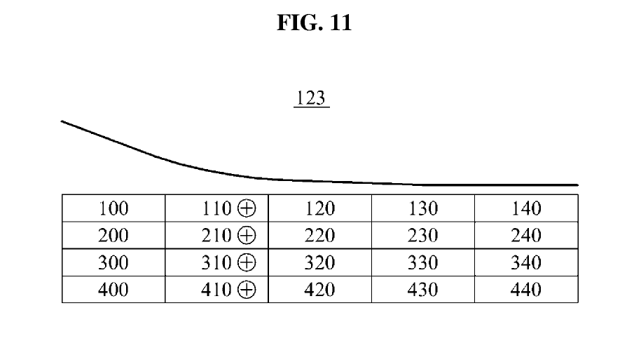

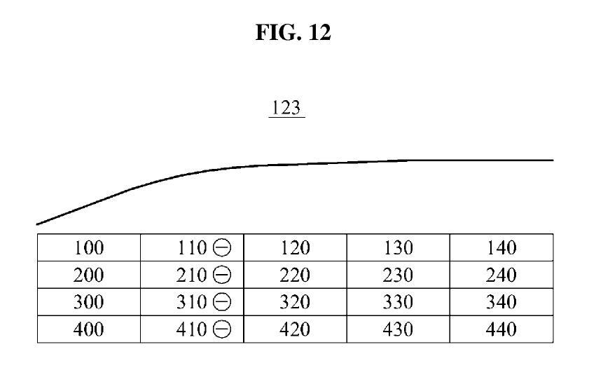

FIGS. 11 through 16 are diagrams schematically illustrating inputs of piezoelectric signals according to exemplary embodiments of the present invention.

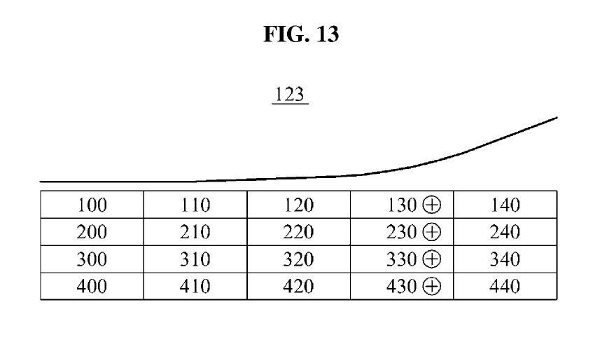

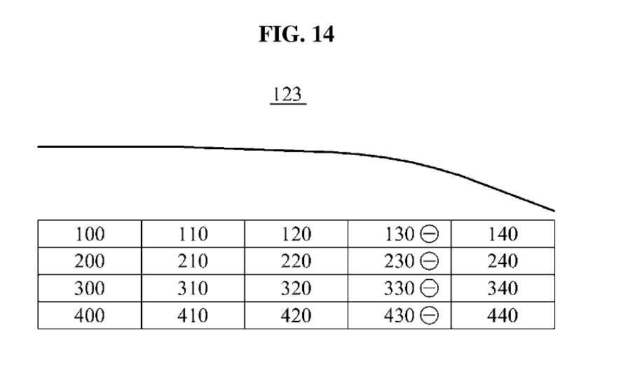

As illustrated in FIG. 11, when a left end of the control display 120 is bent or deformed in an upward direction, positive piezoelectric signals are generated along a line of the cells 110, 210, 310, and 410 among a plurality of the cells 100 to 140, 200 to 240, 300 to 340, and 400 to 440. As illustrated in FIG. 11, when the left end of the control display 120 is bent in a downward direction, negative piezoelectric signals are generated along the line of the cells 110, 210, 310, and 410 among the plurality of the cells 100 to 140, 200 to 240, 300 to 340, and 400 to 440. Accordingly, the control unit 30 determines whether the left end of the control display 120 is bent in an upward direction or a downward direction, and generates a corresponding As illustrated in FIGS. 13 and 14, if the right end of the control display 120 is bent in an upward direction and a downward direction, respectively, respective positive and negative piezoelectric signals are generated along a line of the cells 130, 230, 330, and 430 among the plurality of the cells 100 to 140, 200 to 240, 300 to 340, and 400 to 440. Accordingly, the control unit 30 determines whether the right end of the control display 120 is bent in an upward direction or a downward direction, and generates a corresponding control signal.

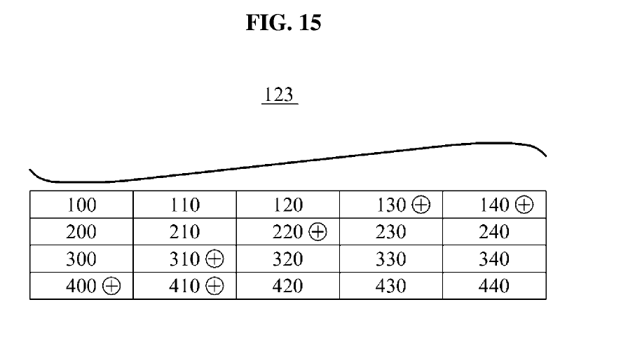

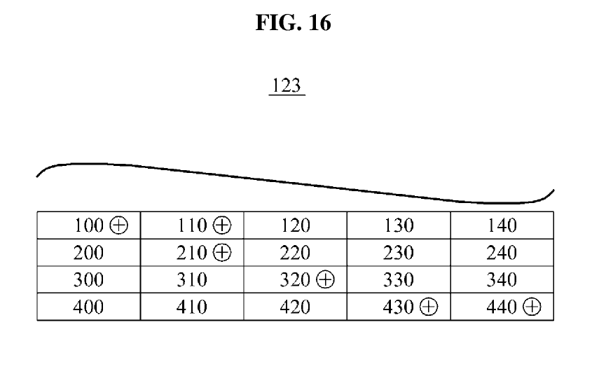

As illustrated in FIG. 15, if the left end of the control display 120 is twisted in an upward direction and the right end is twisted in an downward direction, positive piezoelectric signals are generated in cells 130, 140, 220, 310, 400, and 410 among a plurality of the cells 100 to 140, 200 to 240, 300 to 340, and 400 to 440 of the control display 120. As illustrated in FIG. 16, if the left end of the control display 120 is twisted in an downward direction and the right end is twisted in an upward direction, positive piezoelectric signals are generated in the cells 100, 110, 210, 320, 430, and 440 among a plurality of the cells 100 to 140, 200 to 240, 300 to 340, and 400 to 440 of the control display 120.

Table 2 shows six piezoelectric signals, based on six variations of the control display 120 according to exemplary embodiments of the present invention.

TABLE 2

| | | | | | UI example |
|---|---|---|---|---|---|
| | | | | UI example | (Music |
| Six motions | | | Motion sensor | (Game control) | Video Play) |
| Bent | Left | Upward | 110, 210, 310, 410 (+) | Move forward | Rewind |
| | | direction | | left | |
| | | Downward | 110, 210, 310, 410 (−) | Move rear left | Previous |
| | | direction | | | track |
| | Right | Upward | 130, 230, 330, 430 (+) | Move forward | Fast forward |
| | | direction | | right | |
| | | Downward | 130, 230, 330, 430 (−) | Move rear right | Next track |
| | | direction | | | |

| | | | | |
|---|---|---|---|---|
| Twisted | Left end upward | 130, 140, 220, 310, 400, | Move forward | Play |
| | direction, | 410 (+) | | |
| | while right end | | | |
| | downward direction | | | |
| | Left end downward | 100, 110, 210, 320, 430, | Move rear | Stop |
| | direction, | 440 (+) | | |
| | while right end upward | | | |
| | direction | | | |

Although cell numbers of the control display 120 including a plurality of the cells 100 to 140, 200 to 240, 300 to 340, and 400 to 440 as well as the motion states in Table 2 are described, aspects of the present invention are not limited thereto such that variations may be made, based on a variety of conditions, such as a type, a shape, a granularity of the piezoelectric member and/or a size of the flexible terminal 1 to which the control display 120 is applied.

Exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, a flexible terminal 1 having a configuration such that a control signal may be inputted based on the input of a touch signal as well as a piezoelectric signal to obtain the diversity of controllability. According to exemplary embodiments of the present invention, a piezoelectric member may be divided into a plurality of cells through which a piezoelectric signal may be input to thereby improve controllability. According to exemplary embodiments of the present invention, a piezoelectric member may be designed in a variety of manners so as to be applicable to various terminals.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A flexible terminal comprising:
flexible control display to generate a piezoelectric signal in response to a deformation of the flexible control display: and
a control unit configured to process a control signal in response to the piezoelectric signal received through the flexible control display.

2. The flexible terminal of claim 1, wherein the flexible control display comprises:
a piezoelectric member divided into at least one cell in which the piezoelectric signal is generated.

3. The flexible terminal of claim 2, wherein, if the flexible terminal is deformed, a resultant tensile stress in the at least one cell generates the piezoelectric signal corresponding to the control signal.

4. The flexible terminal of claim 2, wherein, if the flexible terminal is deformed, a resultant compressive stress in the at least one cell generates the piezoelectric signal corresponding to the control signal.

5. The flexible terminal of claim 2, wherein the flexible control display comprises:
at least one conductive member formed of a conductive material and connected between the at least one cell and the control unit.

6. The flexible terminal of claim 1, wherein the flexible control display comprises:
a display member to generate an image;
a first piezoelectric member disposed on the display member to generate a piezoelectric signal; and
a first conductive member disposed on the first piezoelectric member.

7. The flexible terminal of claim 1, wherein the flexible control display comprises:
a display member to generate an image;
a first conductive member disposed on the display member;
a first piezoelectric member disposed on the first conductive member to generate a piezoelectric signal;
a second conductive member disposed on the first piezoelectric member; and
a cover member disposed on the second conductive member.

8. The flexible terminal of claim 1, wherein the flexible control display comprises:
a display member to generate an image;
a first piezoelectric member disposed on the display member to generate a piezoelectric signal;
a first conductive member disposed on the first piezoelectric member;
a second piezoelectric member disposed on the first conductive member to generate a piezoelectric signal;
a second conductive member disposed on the second piezoelectric member; and
a cover member disposed on the second conductive member.

9. The flexible terminal of claim 6, further comprising:
at least one conductive electrode disposed between the second conductive member and the cover member.

10. The flexible terminal of claim 6, further comprising:
at least one piezoelectric electrode disposed between the second conductive member and the cover member.

11. A flexible terminal comprising:
a flexible control display to generate a touch signal in response to a touch and to generate a piezoelectric signal in response to a deformation of the flexible control display;
a piezoelectric member divided into at least one cell within which a piezoelectric signal is generated;
at least one conductive member connected to the at least one cell to receive the piezoelectric signal, and
a control unit which processes a control signal corresponding to the touch signal and the piezoelectric signal.

12. The flexible terminal of claim 11 wherein the control unit blocks a touch signal if the piezoelectric signal is greater than a reference value.

13. A method for controlling a flexible terminal, the method comprising:
determining whether a piezoelectric signal exceeds a reference value; and
processing a control signal corresponding to the piezoelectric signal if the piezoelectric signal exceeds the reference value.

14. The method of claim 13, further comprising:
generating the piezoelectric signal in response to a deformation of the flexible terminal.

15. The method of claim 14, wherein the deformation of the flexible terminal is at least one of a bending and a twisting of the flexible terminal.

16. The method of claim 13, wherein the processing of the control signal comprises controlling play of a game or playback of a media file.

17. The method of claim 13, further comprising:
determining if a touch signal is inputted if the piezoelectric signal does not exceed the reference value; and
processing a control signal corresponding to the touch signal if the touch signal is determined to be inputted.

18. The method of claim 13, further comprising:
blocking a touch signal if the piezoelectric signal exceeds the reference value.

19. The method of claim 13, wherein the determining whether the piezoelectric signal exceeds the reference value comprises:
determining whether piezoelectric values of cells within the flexible terminal exceed the reference value.

20. The method of claim 19, wherein the processing of the control signal depends upon in which cells the piezoelectric values exceed the reference value.
